(19) United States
(12) Patent Application Publication
(10) Pub. No.: US 2009/0031917 A1
(43) Pub. Date: Feb. 5, 2009

(54) Kit and Method for Converting a Locomotive from a First Configuration to a Second Configuration

(76) Inventors: Ajith Kuttannair Kumar, Erie, PA (US); Bret Dwayne Worden, Union City, PA (US)

Correspondence Address: BEUSSE WOLTER SANKS MORA & MAIRE, P.A., 390 NORTH ORANGE AVENUE, SUITE 2500, ORLANDO, FL, 32801, US

(21) Appl. No.: 11/833,851

(22) Filed: Aug. 3, 2007

(51) Int. Cl. B61C 9/48; B60L 3/10; B61C 15/04

(52) U.S. Cl. 105/35; 105/453; 105/73; 105/75; 105/82; 177/137; 903/916

(57) ABSTRACT

A kit and method for converting a locomotive from a first configuration to a second configuration having a different operational capability. The kit includes a traction assembly including a mechanical subassembly configured to mechanically couple a first axle of a truck to a traction system of the locomotive; and an electromotive subassembly configured to electromotively couple the first axle to the traction system of the locomotive via the mechanical subassembly. When the kit is installed in the locomotive, the locomotive is converted from the first configuration having the first axle uncoupled from the traction system and a second axle of the truck coupled to the traction system to the second configuration having the first axle coupled to the traction system and a second axle coupled to the traction system.

### FIELD OF THE INVENTION

The subject matter herein relates to locomotives, and, more particularly, to a kit and method for converting a locomotive from a first configuration to a second configuration.

### BACKGROUND OF THE INVENTION

A diesel-electric locomotive typically includes a diesel internal combustion engine coupled to drive a rotor of at least one traction alternator to produce alternating current (AC) electrical power. The traction alternator may be electrically coupled to power one or more electric traction motors mechanically coupled to apply torque to one or more axles of the locomotive. The traction motors may include AC motors operable with AC power, or direct current motors operable with direct current (DC) power. For DC motor operation, a rectifier may be provided to convert the AC power produced by the traction alternator to DC power for powering the DC motors.

AC-motor-equipped locomotives typically exhibit better performance and have higher reliability and lower maintenance than DC-motor-equipped locomotives. In addition, more responsive individual motor control may be provided in AC-motor-equipped locomotives, for example, via use of inverter-based motor control. However, DC-motor-equipped locomotives are relatively less expensive than comparable AC-motor-equipped locomotives. Thus, for certain hauling applications, such as when hauling relatively light freight and/or relatively short trains, it may be more cost efficient to use a DC-motor-equipped locomotive instead of an AC-motor-equipped locomotive.

For relatively heavy hauling applications, diesel-electric locomotives are typically configured to have two trucks including three powered axles per truck. Each axle of the truck is typically coupled, via a gear set, to a respective motor mounted in the truck near the axle. Each axle is mounted to the truck via a suspension assembly that typically includes one or more springs for transferring a respective portion of a locomotive weight (including a locomotive body weight and a locomotive truck weight) to the axle while allowing some degree of movement of the axle relative to the truck.

A locomotive body weight is typically configured to be about equally distributed between the two trucks. The locomotive weight is usually further configured to be symmetrically distributed among the axles of the trucks. For example, a conventional locomotive weighing 420,000 pounds is typically configured to equally distribute weight to the six axles of the locomotive, so that each axle supports a force of 420,000/6 pounds per axle, or 70,000 pounds per axle.

Locomotives are typically manufactured to distribute weight symmetrically to the trucks and then to the axles of the trucks so that relatively equal portions of the weight of the locomotive are distributed to the axles. Typically, the weight of the locomotive and the power rating of the locomotive determine a tractive effort capability rating of the locomotive that may be expressed as weight times a tractive effort rating. Accordingly, the weight applied to each of the axles times the tractive effort that can be applied to the axle determines a power capability of the corresponding axle. Consequently, the heavier a locomotive, the more tractive effort that it can generate at a certain speed. Additional weight, or ballast, may be added to a locomotive to bring it up to a desired overall weight for achieving a desired tractive effort capability rating. For example, due to manufacturing tolerances that may result in varying overall weights among locomotives built to a same specification, locomotives are commonly configured to be slightly lighter than required to meet a desired tractive effort rating, and then ballast is added to reach a desired overall weight capable of meeting the desired tractive effort rating.

Diesel engine powered locomotives represent a major capital expenditure for railroads, including both the initial purchase of a locomotive, but also the ongoing expense of maintaining and repairing the locomotive. In addition, hauling requirements may change over time for the railroad, so that a locomotive having a certain operating capability at a time of purchase may not meet the hauling needs of the railroad in the future. For example, a railroad looking to purchase a locomotive may only have minimal hauling needs that may be met by a relatively inexpensive low tractive effort capability locomotive, such as a DC powered locomotive having less hauling capability compared to a more expensive relatively high tractive effort locomotive, such as an AC powered locomotive. However, at some point in the useful life of the low tractive effort capability locomotive, hauling needs of the railroad may change, such that the low tractive effort capability locomotive may not be able to provide sufficient hauling capability. As a result, the railroad may need to purchase a more capable high tractive effort capability locomotive, thereby sacrificing a remaining useful life of the low tractive effort capability locomotive.

The inventors have recognized that by manufacturing one type of an item, instead of various different types of the item, a manufacturer may be able to reduce manufacturing costs by streamlining production lines. For example, a locomotive manufacturer may be able to reduce manufacturing costs by producing a single type of locomotive, such as a high tractive effort capability AC powered locomotive, instead of producing two types of locomotives, such as a high tractive effort capability AC powered locomotive and a low tractive effort capability DC powered locomotive. Thus, what is needed is a locomotive that, for example, may be easily reconfigured as operating requirements for the locomotive change over its life. There is also a continuing need to reduce manufacturing costs. What is also needed is kit for converting a locomotive from one configuration to another. Accordingly, the inventors have innovatively developed a reconfigurable locomotive that can easily be modified with a kit, for example, to upgrade a traction capability of the locomotive.

### BRIEF SUMMARY OF THE INVENTION

An example embodiment of the invention includes a kit for converting a locomotive from a first configuration to a second configuration. The kit includes a traction assembly including a mechanical subassembly configured to mechanically couple a first axle of a truck to a traction system of the locomotive; and an electromotive subassembly configured to electromotively couple the first axle to the traction system of the locomotive via the mechanical subassembly. When the kit is installed in the locomotive, the locomotive is converted from the first configuration to the second configuration, the second configuration having a different operational capability than the first configuration. The first configuration comprises the first axle uncoupled from the traction system and coupled to the truck by a first suspension assembly configured to apply to the first axle a first portion of a weight of the locomotive, and a second axle of the truck coupled to the traction system and coupled to the truck by a second suspension assembly configured to apply to the second axle a second portion of the weight of the locomotive different from the first portion. The second configuration comprises the first axle and the second axle coupled to the traction system and to the truck so that the first portion and second portion are symmetric.

In another example embodiment, the kit includes a traction assembly including a mechanical subassembly configured to mechanically couple a first axle of a truck to a traction system of the locomotive and an electromotive subassembly configured to electromotively couple the first axle to the traction system of the locomotive via the mechanical subassembly. When the kit is installed in the locomotive, the locomotive is converted from the first configuration to the second configuration, the second configuration having a different operational capability than the first configuration. The first configuration comprises the first axle uncoupled from the traction system and coupled to the truck by a first suspension assembly configured to apply to the first axle a first portion of a weight of the locomotive applied to the truck by the locomotive, a second axle of the truck coupled to the traction system and coupled to the truck by a second suspension assembly configured to apply to the second axle a second portion of the weight of the locomotive different from the first portion, and a third axle coupled to the traction system and coupled to the truck by a third suspension assembly configured to apply to the third axle a third portion of a weight of the locomotive symmetric with the second portion. The second configuration comprises the first axle, the second axle, and the third axle coupled to the traction system of the locomotive and to the truck so that the first portion, the second portion, and the third portion are symmetric.

In another example embodiment, the invention includes a method for converting a locomotive from a first configuration to a second configuration. The method includes configuring a locomotive in a first configuration having a baseline operational capability, wherein the first configuration includes a truck of the locomotive having a first axle uncoupled from the traction system of the locomotive and coupled to the truck by a first suspension assembly configured to apply to the first axle a first portion of a weight of the locomotive and a second axle of the truck coupled to the traction system and coupled to the truck by a second suspension assembly configured to apply to the second axle a second portion of the weight of the locomotive different from the first portion. The first configuration further comprises an ability to accommodate a kit configured for converting the locomotive to the second configuration having a different operational capability. The method also includes defining a kit comprising a traction assembly, the traction assembly including a mechanical subassembly configured to mechanically couple a first axle of a truck to a traction system of the locomotive and an electromotive subassembly configured to electromotively couple the first axle to the traction system of the locomotive via the mechanical subassembly. The traction assembly is configured for reconfiguring the locomotive in the second configuration, the second configuration having a different operational capability than the first configuration. The method also includes installing the kit onto the locomotive for converting the locomotive from the first configuration to the second configuration.

In another example embodiment, the invention includes a kit for converting a locomotive from a first configuration to a second configuration. The kit includes a traction assembly including means for mechanically coupling a first axle of a truck to a traction system of the locomotive and means for electromotively coupling the first axle to the traction system of the locomotive via the mechanical subassembly. When the kit is installed in the locomotive, the locomotive is converted from the first configuration to the second configuration having a different operational capability than the first configuration. The first configuration comprises the first axle uncoupled from the traction system and coupled to the truck by a first suspension assembly configured to apply to the first axle a first portion of a weight of the locomotive, a second axle of the truck coupled to the traction system and coupled to the truck by a second suspension assembly configured to apply to the second axle a second portion of the weight of the locomotive different from the first portion. The second configuration comprises the first axle and the second axle coupled to the traction system and to the truck so that the first portion and second portion are symmetric.

### BRIEF DESCRIPTION OF THE DRAWINGS

A more particular description of the invention briefly described above will be rendered by reference to specific embodiments thereof that are illustrated in the appended drawings. These drawings depict only typical embodiments of the invention and are not therefore to be considered to be limiting of its scope.

FIG. 1A is a schematic block diagram of an example embodiment of a locomotive configured in a configuration for a baseline operational capability.

FIG. 1B is a schematic block diagram of another example embodiment of a locomotive configured in a configuration for a baseline operational capability.

FIG. 2 is a schematic block diagram of an example embodiment of a kit for converting the locomotive of FIG. 1 from a first configuration to a second configuration.

FIG. 3 is a schematic block diagram of an example embodiment of a locomotive converted to a second configuration with the kit of FIG. 2.

FIG. 4 is a flow diagram of an example embodiment of a method for converting a locomotive from a first configuration having a baseline operational capability to a second configuration having a different operational capability.

### DETAILED DESCRIPTION OF THE INVENTION

Reference will now be made in detail to the embodiments consistent with the invention, examples of which are illustrated in the accompanying drawings. Wherever possible, the same reference numerals are used throughout the drawings and refer to the same or like parts.

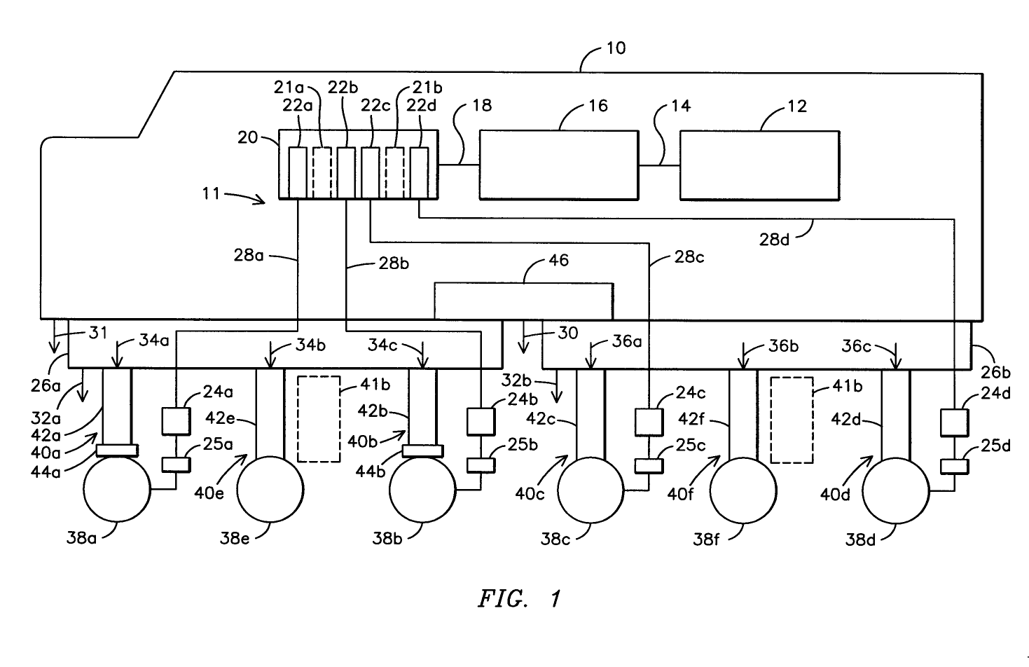

FIG. 1A is a schematic block diagram of an example embodiment of a reconfigurable locomotive 10. The locomotive 10 may include a traction system 11 having a diesel internal combustion engine 12 coupled via shaft 14 to drive a traction alternator 16 for producing AC electrical power 18. The AC electrical power 18 may be provided to a motor controller 20 that may include a one or more inverters 22a-22d. Inverters 22a-22d may be configured to provide electrical power to, and for controlling respective traction motors 24a-24d located in trucks 26a-26b. The inverters 22a-22d may be electrically coupled to the respective traction motors 24a-24d with wiring harnesses 28a-28b. In an aspect of the invention, the traction motors 24a-24d may include AC powered traction motors for converting AC electrical power into a mechanical power. The traction motors 24a-24d may be mechanically coupled to respective gear sets 25a-25d configured to apply power in the form of driving torque to the corresponding powered axle 38a-38d. It should be understood that although an AC type locomotive system is described above, aspects of the present invention may also be used with DC locomotives and other locomotive power configurations as well.

A static weight 30 of the locomotive 10, for example, including a locomotive body weight 31 and truck weights 32a, 32b, is supported by the axles 38a-38f of the trucks 26a-26b. Accordingly, the static weight 30 supported by any one axle may include a portion of the locomotive body weight 31 of the locomotive 10 supported by the truck to which the axle is coupled and the truck weight, e.g., truck weight 32a, 32b. The axles 38a-38f may be coupled to the trucks 26a, 26b by one or more suspension assemblies 40a-40f that may include one or more springs 42a-42f and/or shims 44a, 44b.

In an aspect of the invention, one or more axles of trucks 26a, 26b, such as axles 38e, 38f, may be left un-powered in a baseline configuration. Consequently, the associated assemblies normally deployed with the un-powered axles, such as inverters, traction motors, and/or gear sets, may be absent in a baseline configuration. By reducing a number of traction components, users requiring a less tractive effort capable and/or less powerful locomotive may be able to save on the cost of purchasing such a locomotive compared to a locomotive having a full complement of traction components. Furthermore, manufacturers of such locomotives may save on production costs because they only need to produce one baseline locomotive design and simply add traction components and/or refrain for installing traction components to achieve a desired capability of a locomotive, instead of having to produce entirely different models having different capabilities. Spaces in the locomotive 10 normally occupied by components of the traction system 11, such as a space 41a in the truck 26a normally reserved for housing a traction assembly, and or a space 21a in the motor controller 20, normally reserved for an inverter, may be left vacant in a baseline locomotive design.

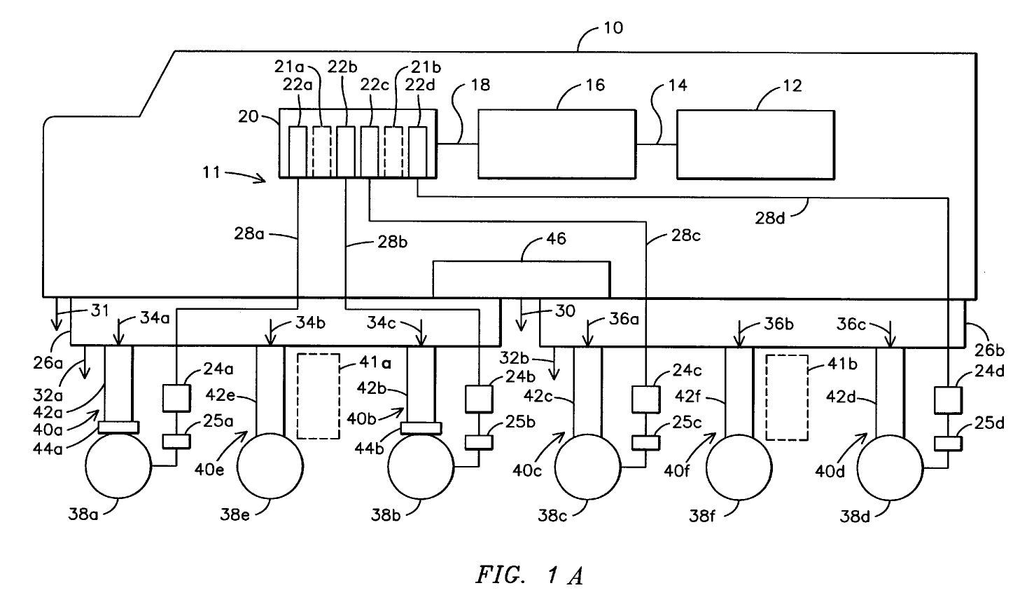

In an example embodiment, the invention includes a kit, such as kit 48 shown in FIG. 2, for converting a locomotive, such as locomotive 10 of FIG. 1B, from a first configuration having a baseline operational capability to a second configuration having a different operational capability. The first configuration may include an axle, such as axle 38e of truck 26a, uncoupled from the traction system 11 of the locomotive 10. Axle 38e may be coupled to the truck 26a by a first suspension assembly, such as suspension assembly 40e, configured to apply to axle 38e a first portion, such as portion 34b, of a locomotive weight 30. The first configuration may also include a second axle, such as axle 38a of the truck 26a coupled to the traction system 11. Axle 38a may be coupled to the truck by a second suspension assembly, such as suspension assembly 40a, configured to apply to axle 38a a second portion, such as portion 34a, of the locomotive weight 30 different from portion 34b applied to axle 38e.

In an example embodiment depicted in FIG. 1A of a locomotive having a three axle truck with one of the axles, e.g. axle 38e, uncoupled from the traction system 11 of the locomotive 10 in a first configuration, the kit 48 may be used to convert the locomotive from the first configuration to the second configuration. The second configuration may include axle 38e, the axle 38a and axle 38b coupled to the traction system 11 of the locomotive 10 and coupled to the truck 26a so that the portion 34b, portion 34a, and portion 34c applied to the respective axles 38e, axle 38a, and axle 38b are symmetric.

As shown in FIG. 2, with reference to FIGS. 1A and 1B, the kit 48 may include a traction assembly 51 for installation onto locomotive 10. The traction assembly 51 may include an electromotive subassembly 53 configured to electrically couple an axle, such as a previously un-powered axle 38e, of a truck 26a of the locomotive 10 to a traction system 11 of the locomotive 10. The traction assembly 51 may include a mechanical subassembly 54 configured to mechanically couple the axle 38e to the traction system 11 of the locomotive 10. When installed on the locomotive 10, the traction assembly 51 converts the locomotive 10 from the first configuration to the second configuration having axle 38e coupled to the traction system 11 of the locomotive 10 and axle 38a coupled to the traction system 11. In an aspect of the invention, axle 38a and axle 38e may be coupled by respective suspension assemblies 40a, 40e to the truck 26a, so that portion 34a and portion 34b are symmetric.

In example embodiments, the electromotive subassembly 53 may include an electric motor 50, such as an alternating current traction motor for mounting to the truck 26a for driving the axle 38e. The electromotive subassembly 53 may also include a motor controller 52 for controlling the electric motor 50. The motor controller 52 may further include an inverter 55 to provide variable control of the motor 50. The electromotive subassembly 53 may further include a wiring harness 58 for electrically coupling the electric motor 50 to the motor controller 52. The mechanical subassembly 54 may include a gear set 57 for mechanically coupling the electric motor 50 to an axle such as axle 38e.

In an aspect of the invention, the first configuration may include areas in the locomotive 10 reserved for receiving components of the kit 48. For example, spaces in the locomotive 10 normally occupied by components of the traction system 11, such as a space 41 in the truck 26a normally reserved for housing a traction assembly, and or a space 21 in the motor controller 20, normally reserved for an inverter, may be left vacant when the locomotive 10 is configured in the first configuration for a baseline operational capability. Accordingly, such reserved spaces may be pre-configured for receiving components of the kit 48 when it is desired to convert the locomotive from the first configuration to the second configuration.

In another example embodiment, the kit 48 may include a replacement suspension component 56 configured for replacing a suspension component in at least one of a suspension assembly 40a associated with a powered axle 38a and a suspension assembly 40b associated with an un-powered axle 38e. The replacement suspension component 56 may be configured to provide symmetric weight distribution of portion 34a and portion 34b in the second configuration, such as by equalizing portion 34a and portion 34b. In example embodiments, replacement suspension component 56 may include a spring 60 and/or a shim 62. The spring 60 may have a characteristic, such as a spring constant and/or spring geometry, equivalent to an existing locomotive suspension spring, such as spring 42c. In another embodiment, the spring 60 may have a different characteristic than an existing spring, such as spring 42a. In an embodiment, the shim 62 may be installed in a suspension assembly of an axle receiving the traction assembly of the kit and/or different than an axle receiving the traction assembly of the kit. In yet another example embodiment, the kit 48 may include a suspension component configured for removal, such as a shim 44a, from a suspension assembly of the locomotive 10.

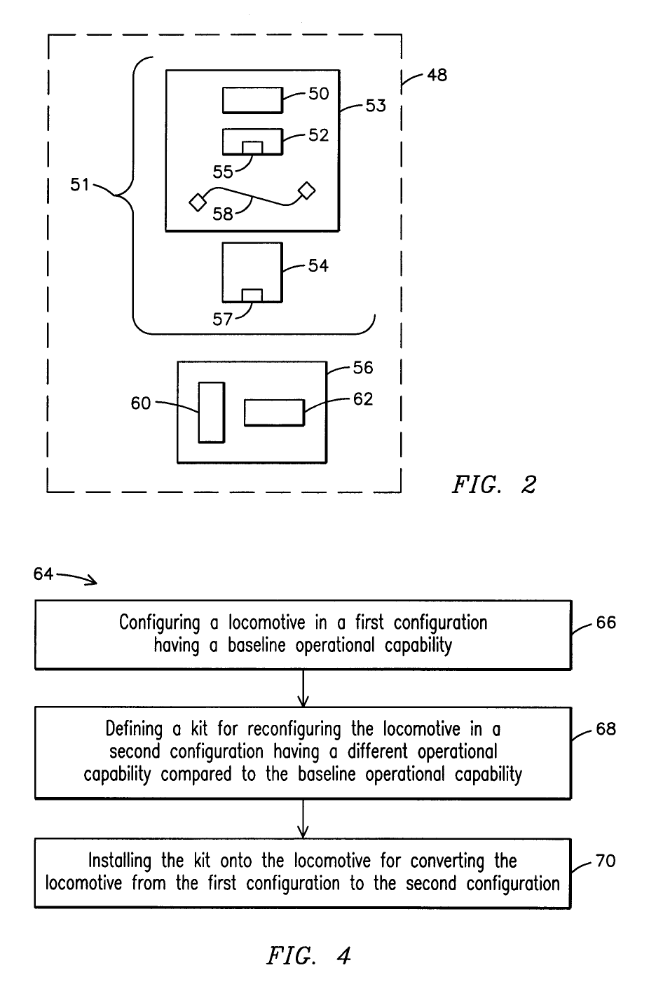

FIG. 3 is a schematic block diagram of an example embodiment of the locomotive 10 of FIG. 1A converted to a second configuration by installing components of the kit 48 of FIG. 2. For example, the converted locomotive 10 may include an inverter 55 from the kit 48 installed in space 21a and traction assembly 51 from the kit 48 installed in space 41a. The inverter 55 and traction assembly 51 may be electrically coupled with wiring harness 58 from the kit 48.

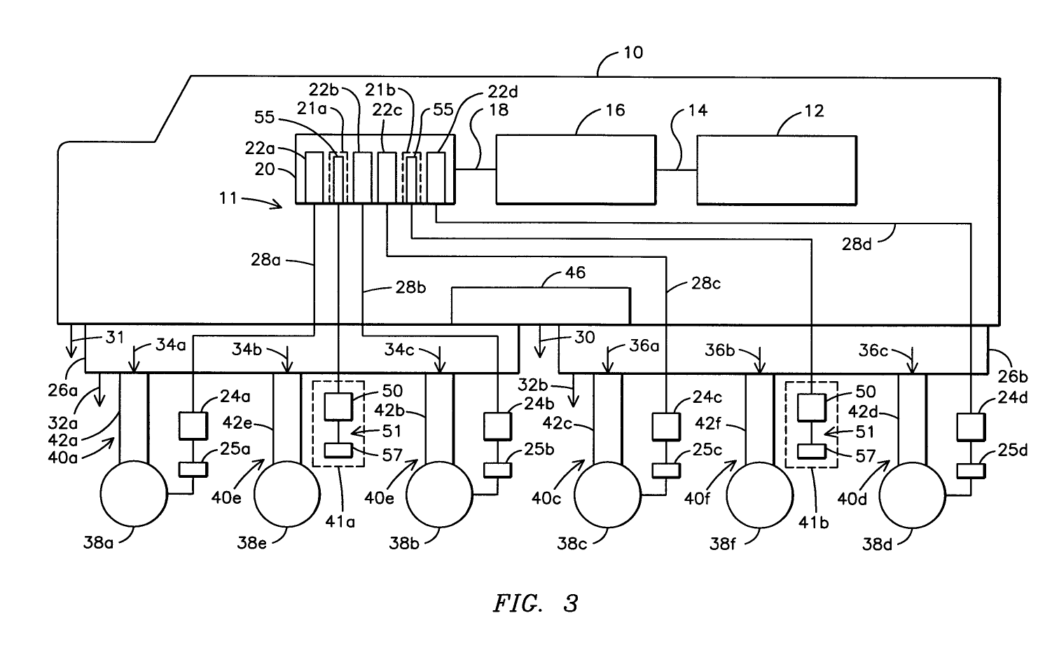

In another example embodiment depicted in the flow diagram 64 of FIG. 4, and with reference to FIGS. A and 1B, a method for converting the locomotive 10 from a first configuration having a baseline operational capability to a second configuration having a different operational capability may include configuring 66 the locomotive 10 in a first configuration having the baseline operational capability. The first configuration may include an axle, such as axle 38e of truck 26a, uncoupled from the traction system 11 of the locomotive 10. Axle 38e may be coupled to the truck 26a by a first suspension assembly, such as suspension assembly 40e, configured to apply to axle 38e a first portion, such as portion 34b, of a locomotive weight 30. The first configuration may also include a second axle, such as axle 38a of the truck 26a coupled to the traction system 11. Axle 38a may be coupled to the truck by a second suspension assembly, such as suspension assembly 40a, configured to apply to axle 38a a second portion, such as portion 34a, of the locomotive weight 30 different from portion 34b applied to axle 38e. In an aspect of the invention, the first configuration comprises an ability to accommodate a kit 48 configured for converting the locomotive 10 to a second configuration having a different operational capability.

The method may also include defining 68 a kit 48 comprising a traction assembly 51 including an electromotive subassembly 53, for example, for electrically coupling axle 38e to the traction system 11 of the locomotive 10 and a mechanical subassembly 54 for mechanically coupling the axle 38e to the traction system 11 for reconfiguring the locomotive 10 in a second configuration having an different operational capability compared to the baseline operational capability. The method may also include installing 70 the kit 48 onto the locomotive 10 for converting the locomotive 10 from the first configuration to the second configuration.

In a further aspect of the invention, the method may include installing the kit 48 on a fielded locomotive. For example, for a railroad desiring to upgrade a hauling capacity of a baseline-configured locomotive 10, the kit 48 may be installed as a retrofit at a depot facility. In another aspect, the method may include installing the kit 48 on a new locomotive 10 during manufacture of the locomotive 10. For example, an assembly line may be configured for producing locomotives in a first configuration having a baseline operation capability. Along a different portion of the assembly line, the first configuration may be converted to the second configuration by installing the kit 48 as part of an alternate assembly line process for producing locomotives 10 having a different operation capability that the baseline capability. 24. In yet another aspect of the invention, the method may include removing at least one component of the kit 48 when the different operating capability is no longer needed and adding the removed component to a spare parts inventory for later use.

In yet another aspect of the invention, converting the locomotive from a first configuration to a second configuration and vice versa may also include configuring a weight of the locomotive according to the desired configuration. For example, in the first configuration having four powered axles, the weight of the locomotive may be less than the weight of the second configuration having six powered axles due to absence of the traction assembly, such as the gear sets and electric motors, required to drive the two additional axles. Accordingly, in the first configuration, the locomotive may be configured for having more weight than in the second configuration. For example, in the first configuration, the locomotive may be able to carry more consumable material, such as fuel, sand, water, oil, etc. and/or ballast than when the locomotive is configured in the second configuration. The additional weight capacity may correspond to an amount of weight saved by not having the kit components installed that convert the locomotive from the first configuration to the second configuration.

Accordingly, the kit may include a capacity modifying member configured to modify a capacity of a storage tank, such as a fuel, sand, water, oil, etc., storage tank, of the locomotive when the locomotive is configured in the second configuration. In an embodiment, the member, when installed in the storage tank, may be configured to reduce a volume in the storage tank, so that a weight reduction realized by the volume reduction corresponds to an amount of weight added by kit components when the kit is installed to convert the locomotive to the second configuration. In another embodiment, the kit may include a ballast component configured to be removed from the locomotive so that a weight reduction realized by the ballast component removal corresponds to an amount of weight added by kit components when the kit is installed to convert the locomotive to the second configuration.

While exemplary embodiments of the invention have been described with reference to an exemplary embodiment, it will be understood by those skilled in the art that various changes, omissions and/or additions may be made and equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A kit for converting a locomotive from a first configuration to a second configuration, the kit comprising:
a traction assembly including:
a mechanical subassembly configured to mechanically couple a first axle of a truck to a traction system of the locomotive; and
an electromotive subassembly configured to electromotively couple the first axle to the traction system of the locomotive via the mechanical subassembly,
wherein, when the kit is installed in the locomotive, the locomotive is converted from the first configuration to the second configuration, the second configuration having a different operational capability than the first configuration;
wherein further the first configuration comprises the first axle uncoupled from the traction system and coupled to the truck by a first suspension assembly configured to apply to the first axle a first portion of a weight of the locomotive, and a second axle of the truck coupled to the traction system and coupled to the truck by a second suspension assembly configured to apply to the second axle a second portion of the weight of the locomotive different from the first portion,
wherein further the second configuration comprises the first axle and the second axle coupled to the traction system and to the truck so that the first portion and second portion are symmetric.

2. The kit of claim 1, wherein the electromotive subassembly comprises an electric motor configured to mount to the truck to drive the first axle.

3. The kit of claim 2, wherein the electromotive subassembly comprises a motor controller configured to control the electric motor.

4. The kit of claim 3, wherein the motor controller comprises an inverter.

5. The kit of claim 3, wherein the electromotive subassembly comprises a wiring harness configured to electrically couple the electric motor to the motor controller.

6. The kit of claim 1, wherein the mechanical subassembly comprises a gear set configured to mechanically couple the electric motor to the first axle.

7. The kit of claim 1, further comprising a replacement suspension component configured to replace a suspension component in the first suspension assembly or the second suspension assembly to provide symmetry between the first portion and the second in the second configuration.

8. The kit of claim 7, wherein the replacement suspension component comprises a spring.

9. The kit of claim 7, wherein the replacement suspension component comprises a shim.

10. The kit of claim 1, further comprising a suspension component configured to be removed from the first suspension assembly or the second suspension assembly.

11. The kit of claim 1, further comprising a ballast component configured to be removed from the locomotive.

12. The kit of claim 1, further comprising a capacity modifying member configured to modify a capacity of a storage tank on-board the locomotive.

13. A kit for converting a locomotive from a first configuration to a second configuration, the kit comprising:
a traction assembly including:
a mechanical subassembly configured to mechanically couple a first axle of a truck to a traction system of the locomotive; and
an electromotive subassembly configured to electromotively couple the first axle to the traction system of the locomotive via the mechanical subassembly;
wherein when the kit is installed in the locomotive, the locomotive is converted from the first configuration to the second configuration, the second configuration having a different operational capability than the first configuration;
wherein further the first configuration comprises the first axle uncoupled from the traction system and coupled to the truck by a first suspension assembly configured to apply to the first axle a first portion of a weight of the locomotive applied to the truck by the locomotive, a second axle of the truck coupled to the traction system and coupled to the truck by a second suspension assembly configured to apply to the second axle a second portion of the weight of the locomotive different from the first portion, and a third axle coupled to the traction system and coupled to the truck by a third suspension assembly configured to apply to the third axle a third portion of a weight of the locomotive symmetric with the second portion,
wherein further the second configuration comprises the first axle, the second axle, and the third axle coupled to the traction system of the locomotive and to the truck so that the first portion, the second portion, and the third portion are symmetric.

14. The kit of claim 13, wherein the electromotive subassembly comprises an electric motor for mounting to the truck to drive the first axle.

15. The kit of claim 13, wherein the mechanical subassembly comprises a gear set for mechanically coupling the electric motor to the first axle.

16. A method for converting a locomotive from a first configuration to a second configuration, the method comprising:
configuring a locomotive in a first configuration having a baseline operational capability;
wherein the first configuration comprises:
a truck of the locomotive having a first axle uncoupled from the traction system of the locomotive and coupled to the truck by a first suspension assembly configured to apply to the first axle a first portion of a weight of the locomotive and a second axle of the truck coupled to the traction system and coupled to the truck by a second suspension assembly configured to apply to the second axle a second portion of the weight of the locomotive different from the first portion,
wherein the first configuration further comprises an ability to accommodate a kit configured for converting the locomotive to the second configuration having a different operational capability;
defining a kit comprising a traction assembly; said traction assembly comprising:
a mechanical subassembly configured to mechanically couple a first axle of a truck to a traction system of the locomotive; and
an electromotive subassembly configured to electromotively couple the first axle to the traction system of the locomotive via the mechanical subassembly;
wherein the traction assembly is configured for reconfiguring the locomotive in the second configuration, the second configuration having a different operational capability than the first configuration; and
installing the kit onto the locomotive for converting the locomotive from the first configuration to the second configuration.

17. The method of claim 21, further comprising installing the kit on a fielded locomotive.

18. The method of claim 21, further comprising installing the kit on a new locomotive during manufacture of the locomotive.

19. The method of claim 21, further comprising;
removing at least one component of the kit when the different operating capability is no longer needed; and
adding the at least one component to a spare parts inventory.

20. A kit for converting a locomotive from a first configuration to a second configuration, the kit comprising:
a traction assembly including:
means for mechanically coupling a first axle of a truck to a traction system of the locomotive; and
means for electromotively coupling the first axle to the traction system of the locomotive via the mechanical subassembly,
wherein when the kit is installed in the locomotive, the locomotive is converted from the first configuration to the second configuration having a different operational capability than the first configuration;
wherein further the first configuration comprises the first axle uncoupled from the traction system and coupled to the truck by a first suspension assembly configured to apply to the first axle a first portion of a weight of the locomotive, a second axle of the truck coupled to the traction system and coupled to the truck by a second suspension assembly configured to apply to the second axle a second portion of the weight of the locomotive different from the first portion,
wherein further the second configuration comprises the first axle and the second axle coupled to the traction system and to the truck so that the first portion and second portion are symmetric.
